(19) United States
(12) Patent Application Publication
(10) Pub. No.: US 2025/0323376 A1
(43) Pub. Date: Oct. 16, 2025

(54) SECONDARY BATTERY AND METHOD OF CONTROLLING SECONDARY BATTERY

(71) Applicant: TOYOTA JIDOSHA KABUSHIKI KAISHA, Toyota-shi (JP)

(72) Inventors: Kodai SHINTANI, Toyota-shi (JP); Satoshi Morioka, Okazaki-shi (JP); Seita Iwahashi, Handa-shi (JP); Yuusuke Nose, Kosai-shi (JP); Masahiro Yamada, Kariya-shi (JP); Tomohiro Nakamura, Kariya-shi (JP); Yuki Ichikawa, Kariya-shi (JP); Takayuki Hirose, Kariya-shi (JP)

(73) Assignee: TOYOTA JIDOSHA KABUSHIKI KAISHA, Toyota-shi (JP)

(21) Appl. No.: 19/082,496

(22) Filed: Mar. 18, 2025

(30) Foreign Application Priority Data
Apr. 16, 2024 (JP) 2024-066417

(51) Int. Cl. H01M 50/317; H01M 10/48; H01M 50/105; H01M 50/186

(52) U.S. Cl. CPC H01M 50/317; H01M 10/488; H01M 50/105; H01M 50/186

(57) ABSTRACT

A secondary battery includes an exterior member including laminate films, the exterior member having a peripheral edge sealed with the laminate films overlaid and having an enclosed space inside, an electrode module housed in the enclosed space, and a port portion configured to open and close the enclosed space. The port portion includes a seal portion having a peripheral edge sealed except a part and having a bag shape, and a metal pipe. The metal pipe has a first end portion that is disposed outside the seal portion and communicates with the enclosed space, and a second end portion that is disposed inside the seal portion and has an outer peripheral face at least partially fixed with second laminate films on the peripheral edge of the seal portion through a second sealant film.

### CROSS-REFERENCE TO RELATED APPLICATION

This application claims priority to Japanese Patent Application No. 2024-066417 filed on Apr. 16, 2024, incorporated herein by reference in its entirety.

### BACKGROUND

### 1. Technical Field

The disclosure relates to a secondary battery, and a method of controlling the secondary battery.

### 2. Description of Related Art

Japanese Unexamined Patent Application Publication No. 2006-269345 discloses an overvoltage detecting method. The overvoltage detecting method includes detecting, in a stack including a plurality of laminate-sheathed batteries stacked in their thickness direction, a contact pressure on at least one stacked face between the laminate-sheathed batteries inside the stack or a contact pressure on a contact face between the stack and a holding member that holds the stack, and determining that overvoltage has occurred when the contact pressure exceeds a predetermined threshold. Japanese Patent No. 7040294, Japanese Unexamined Patent Application Publication No. 2016-31934, and Japanese Unexamined Patent Application Publication (Translation of PCT application) No. 2023-529685 disclose a structure provided with a port for discharging internal gas in a battery housed in a laminate exterior body.

### SUMMARY

By reducing pressure inside a laminate exterior body, a confining pressure can be applied to an electrode module inside the laminate exterior body due to the differential pressure between the pressure inside the laminate exterior body and the atmospheric pressure outside the laminate exterior body. However, due to, for example, aged deterioration of the laminate exterior body, oxygen or nitrogen may enter the inside of the laminate exterior body in the market environment. If oxygen or nitrogen enters the inside of the laminate exterior body, the pressure inside the laminate exterior body may increase, which may result in an insufficient confining pressure.

Taking the above fact into consideration, it is an object of the present disclosure to provide a secondary battery and a method of controlling the secondary battery that can generate a confining force inside an exterior member formed of laminate films.

A secondary battery according to a first aspect of the present disclosure includes an exterior member, an electrode module, and a port portion. The exterior member includes laminate films, has a peripheral edge sealed with the laminate films overlaid, and has an enclosed space inside. The electrode module is housed in the enclosed space. The port portion is provided in at least a part of the peripheral edge, communicates with the enclosed space, and is configured to open and close the enclosed space. The port portion includes a valve portion. The valve portion has a first end portion, and a second end portion. The first end portion has an inlet through which air flows in and communicates with inside of the enclosed space. The second end portion has an outlet through which air is discharged and is disposed outside the enclosed space. The valve portion is configured to open and close an air passage from the inlet to the outlet.

In the present disclosure, the “enclosed space” does not mean only a strictly enclosed space, but includes a space that is closed, but where air or the like may enter or leave to some extent, for example, due to aged deterioration of the exterior member.

In the secondary battery according to the first aspect of the present disclosure, the port portion that communicates with the enclosed space inside the exterior member and is capable of opening and closing the enclosed space is provided in at least a part of the peripheral edge sealed with the laminate films overlaid. In addition, the port portion includes the valve portion. The valve portion has the first end portion that has the inlet and communicates with the inside of the enclosed space, and the second end portion that has the outlet and is disposed outside the enclosed space. The valve portion is capable of opening and closing the air passage from the inlet to the outlet. Thus, air inside the enclosed space can be allowed to flow in through the inlet and discharged through the outlet by the valve portion bringing the air passage into an open state. This can reduce the pressure inside the enclosed space. Thus, it is possible to generate a confining force inside the exterior member formed of the laminate films.

In a secondary battery according to a second aspect of the present disclosure, in the configuration according to the first aspect, the valve portion may have a flat portion provided at the first end portion, and front and back faces of the flat portion may be fixed with the laminate films on the peripheral edge through a sealant film.

In the secondary battery according to the second aspect of the present disclosure, the front and back faces of the flat portion provided at the first end portion having the inlet are fixed with the laminate films through the sealant film. Thus, compared to a case in which an outer peripheral face of a tubular portion is fixed with the laminate films, the sealability can be improved.

A secondary battery according to a third aspect of the present disclosure includes an exterior member, an electrode module, and a port portion. The exterior member includes laminate films, has a peripheral edge sealed with the laminate films overlaid, and has an enclosed space inside. The electrode module is housed in the enclosed space. The port portion is provided in at least a part of the peripheral edge, communicates with the enclosed space, and is configured to open and close the enclosed space. The port portion includes a seal portion, and a metal pipe. The seal portion includes second laminate films, has a peripheral edge sealed with the second laminate films overlaid except a part of the peripheral edge, and has a bag shape. The metal pipe has a first end portion, and a second end portion other than the first end portion. The first end portion is disposed outside the seal portion and communicates with the enclosed space. The second end portion is disposed inside the seal portion, and has an outer peripheral face at least partially fixed with the second laminate films on the peripheral edge of the seal portion through a second sealant film.

In the secondary battery according to the third aspect of the present disclosure, the seal portion has a bag shape, the first end portion of the metal pipe communicates with the inside of the enclosed space, and the second end portion is disposed inside the seal portion. The outer peripheral face of the second end portion is at least partially fixed with the second laminate films on the peripheral edge of the seal portion through the second sealant film. Thus, air inside the enclosed space can be allowed to flow into the metal pipe through the first end portion, discharged into the seal portion having a bag shape through the second end portion of the metal pipe, and discharged to the outside through the unsealed part of the peripheral edge of the seal portion. This can reduce the pressure inside the enclosed space. Thus, it is possible to generate a confining force inside the exterior member formed of the laminate films.

In a secondary battery according to a fourth aspect of the present disclosure, in the configuration according to the third aspect, the seal portion may have an opening in the part of the peripheral edge, the opening may be closable, and a second opening may be formable by cutting away the closed opening.

In the secondary battery according to the fourth aspect of the present disclosure, the seal portion has the opening in the part of the peripheral edge. In addition, the opening is closable, and the second opening is formable by cutting away the closed opening. This makes it possible to open and close the inside of the seal portion.

A method of controlling a secondary battery according to a fifth aspect of the present disclosure includes, in the secondary battery according to any one of the first to fourth aspects, measuring an internal pressure of the enclosed space, and issuing a warning for depressurizing inside of the enclosed space using the port portion when the internal pressure measured is equal to or higher than a predetermined threshold.

In the method of controlling the secondary battery according to the fifth aspect, when the internal pressure of the enclosed space is equal to or higher than the predetermined threshold, the warning for depressurizing the inside of the enclosed space using the port portion is issued. Thus, a user can recognize the necessity of depressurizing the inside of the enclosed space. When the user recognizes the necessity of the depressurization, the pressure inside the enclosed space can be reduced using the port portion. Thus, a confining force can be generated inside the exterior member formed of the laminate films.

As described above, the secondary battery and the method of controlling the secondary battery according to the aspects of the present disclosure have an excellent effect of generating a confining force inside the exterior member formed of laminate films.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a secondary battery according to an embodiment of the present disclosure in a stacking direction;

FIG. 2A is an explanatory diagram for describing a process of forming an exterior member in the secondary battery of FIG. 1;

FIG. 2B is an explanatory diagram for describing the process of forming the exterior member in the secondary battery of FIG. 1;

FIG. 2C is an explanatory diagram for describing the process of forming the exterior member in the secondary battery of FIG. 1;

FIG. 2D is an explanatory diagram for describing the process of forming the exterior member in the secondary battery of FIG. 1;

FIG. 2E is an explanatory diagram for describing the process of forming the exterior member in the secondary battery of FIG. 1;

FIG. 3A is an explanatory diagram for describing a process of assembling the exterior member in the secondary battery of FIG. 1;

FIG. 3B is an explanatory diagram for describing the process of assembling the exterior member in the secondary battery of FIG. 1;

FIG. 3C is an explanatory diagram for describing the process of assembling the exterior member in the secondary battery of FIG. 1;

FIG. 3D is an explanatory diagram for describing the process of assembling the exterior member in the secondary battery of FIG. 1;

FIG. 4A is an explanatory diagram for describing a process of forming a port portion and a method of using the port portion;

FIG. 4B is an explanatory diagram for describing the process of forming the port portion and the method of using the port portion;

FIG. 4C is an explanatory diagram for describing the process of forming the port portion and the method of using the port portion;

FIG. 4D is an explanatory diagram for describing the process of forming the port portion and the method of using the port portion;

FIG. 5 is a flowchart showing a method of controlling the secondary battery according to the embodiment of the present disclosure;

FIG. 6 is an explanatory diagram for describing the amount of air entering the exterior member;

FIG. 7A is an explanatory diagram for describing a process of forming a port portion and a method of using the port portion in another embodiment;

FIG. 7B is an explanatory diagram for describing the process of forming the port portion and a method of using the port portion in the other embodiment; and

FIG. 7C is an explanatory diagram for describing the process of forming the port portion and a method of using the port portion in the other embodiment.

### DETAILED DESCRIPTION OF EMBODIMENTS

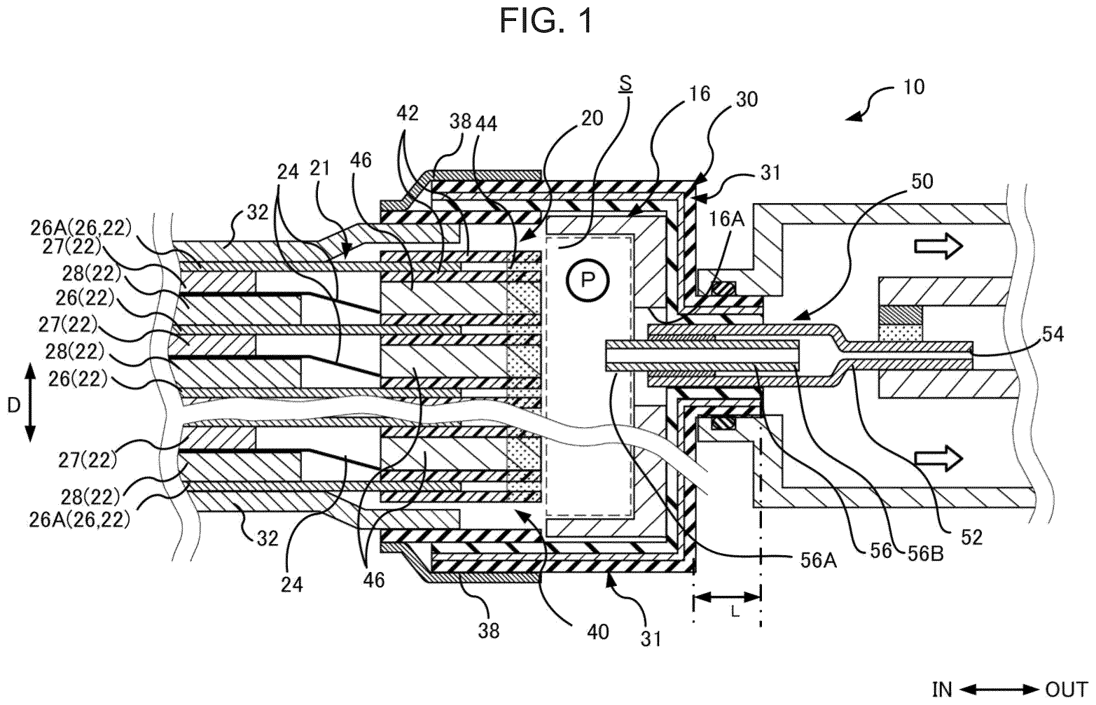

Hereinbelow, a secondary battery 10 according to a first embodiment of the present disclosure will be described with reference to the drawings. Note that in the description of the drawings, identical or equivalent elements are designated by the same reference signs, and redundant description will be omitted. In addition, in the drawings, duplicate reference signs may be omitted as appropriate. In FIG. 1, the thickness of each constituent element and the thickness ratio between the constituent elements are exaggerated for easy description and may differ from the actual ones.

The secondary battery 10 of the present embodiment is, as an example, a bipolar secondary battery and is used, for example, as batteries for various vehicles, such as a forklift, a hybrid electric vehicle, and a battery electric vehicle. The secondary battery 10 is, for example, a nickel-metal hydride secondary battery or a lithium ion secondary battery. The secondary battery 10 may be, for example, an electric double-layer capacitor.

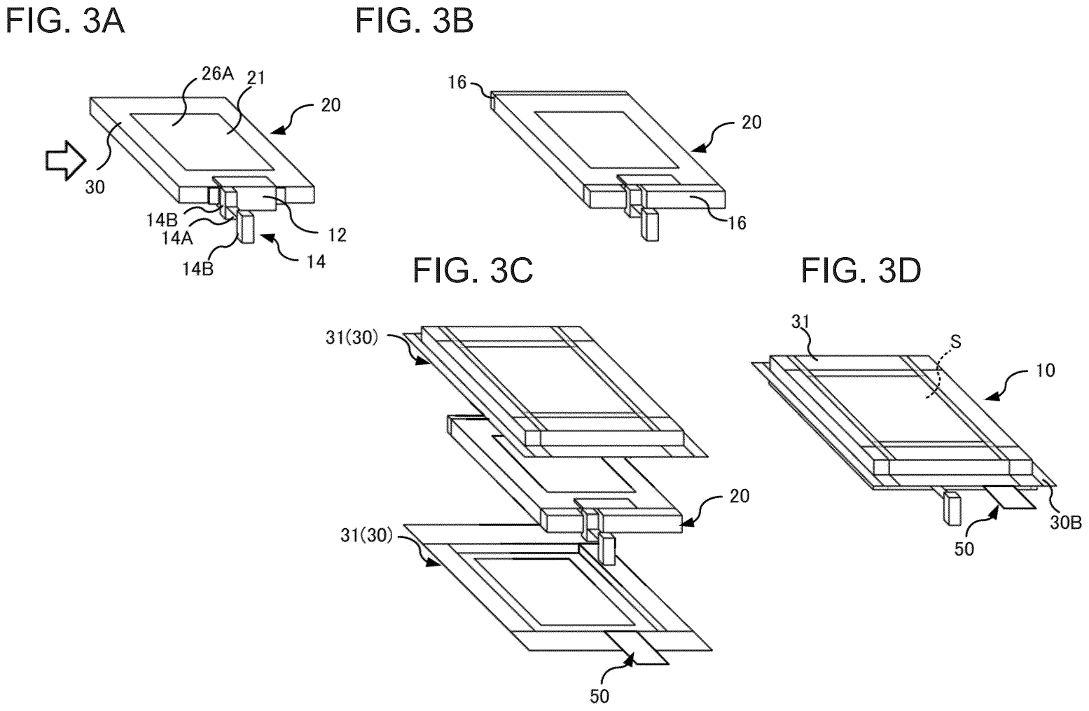

As shown in FIG. 1, the secondary battery 10 includes an electrode module 20, and an exterior member 30 that is disposed enclosing the electrode module 20. The electrode module 20 includes an electrode stack 21, and a seal portion 40 that is disposed surrounding the electrode stack 21. The electrode stack 21 includes a plurality of bipolar electrodes 22. The bipolar electrodes 22 are stacked with a separator 24 interposed therebetween. In the present embodiment, as an example, the electrode module 20 has, for example, a rectangular shape when viewed in the stacking direction (refer to FIGS. 3A, 3B, 3C, and 3D).

Each bipolar electrode 22 includes a current collector 26 having a rectangular sheet shape, a positive electrode layer 27 bonded to one face of the current collector 26, and a negative electrode layer 28 bonded to the other face of the current collector 26, the current collector 26, the positive electrode layer 27, and the negative electrode layer 28 being integrated together. In the electrode stack 21 of the present embodiment, the current collectors 26 are stacked at both ends (extreme ends) in the stacking direction D, and the current collectors 26 stacked at the extreme ends are referred to as end current collectors 26A.

The seal portion 40 is formed of, for example, an insulating resin, and formed in a frame shape on a peripheral edge portion of the electrode stack 21 to surround the electrode stack 21. The seal portion 40 includes a pair of holding seal materials 42, an outer periphery holding seal portion 44, and a spacer 46. Each of the holding seal materials 42 is joined to a peripheral edge portion of an upper face or a lower face of each current collector 26, and the holding seal materials 42 hold each current collector 26 from both sides in the stacking direction D.

In addition, a cover member 16, which will described further below, is disposed outside the seal portion 40 on each short side of the electrode stack 21.

In the present embodiment, a plurality of spaces is provided inside the electrode module 20. Each of the spaces is airtightly and liquid-tightly sealed by the seal portion 40. An electrolytic solution (not shown) containing, for example, a non-aqueous solvent and a supporting salt is stored in each space. The separator 24, the positive electrode layer 27, and the negative electrode layer 28 are impregnated with the electrolytic solution.

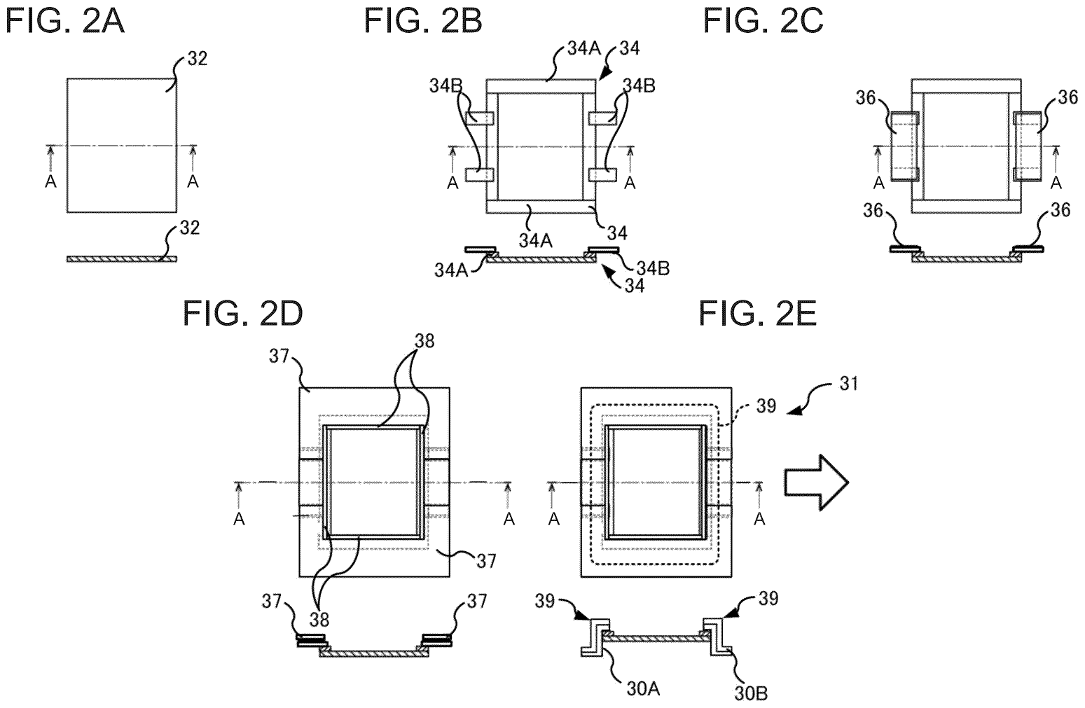

The exterior member 30 is disposed enclosing the electrode module 20 and includes a pair of exterior bodies 31. Each of the exterior bodies 31 is a laminate film formed by laminating film materials. In the present embodiment, the exterior member 30, that is, the exterior body 31 is an aluminum laminate film as an example. Hereinbelow, an example of a method of forming the exterior body 31 will be described. In an A-A sectional view of each of the processes in FIGS. 2A, 2B, 2C, 2D, and 2E, a double-sided laminate film 36 and a highly-formable laminate film 37 are described as members made of one film. However, the double-sided laminate film 36 and the highly-formable laminate film 37 are actually laminate films including a plurality of films laminated.

As shown in FIG. 2A, first, aluminum foil 32 that has a rectangular shape in plan view and has a thickness of t=0.1 mm is placed as an example of an electrically conductive metal layer. Next, as shown in FIG. 2B, a sealant film 34 that provides a heat-seal sealability is disposed on a peripheral edge portion of the aluminum foil 32 as a sealing process. As an example, the sealant film 34 includes an acid modified polypropylene (PPa) layer of 25 μm, a polypropylene (PP) layer of 50 μm, and a PPa layer of 25 μm that are laminated in this order from the aluminum foil 32 side, and has a thickness of 100 μm. The sealant film 34 includes strip-shaped frames 34A that are disposed on four sides of the aluminum foil 32, and projections 34B that are disposed projecting from the aluminum foil 32 at both long sides of the aluminum foil 32 and spaced apart from each other. Each projection 34B is disposed with one end overlapping a part of the frame 34A and the other end projecting in the short direction of the aluminum foil 32.

Next, as shown in FIG. 2C, the double-sided laminate film 36 is disposed overlapping the two projections 34B that are adjacent to each other in the longitudinal direction of the aluminum foil 32. The double-sided laminate film 36 has a rectangular shape, has adhesive layers bonded to both sides, and is located inside the adjacent projections 34B in the longitudinal direction. In addition, as an example, the double-sided laminate film 36 is disposed such that an inner end in the short direction is located inside the projections 34B and an outer end is substantially aligned with outer ends of the projections 34B. As an example, the double-sided laminate film 36 includes a PP layer of 70 μm, an aluminum layer of 40 μm, and a PP layer of 70 μm that are laminated in this order from the aluminum foil 32 side, and has a thickness of 180 μm.

Next, as shown in FIG. 2D, two highly-formable laminate films 37 are disposed facing each other with a space therebetween in the longitudinal direction of the aluminum foil 32. Each highly-formable laminate film 37 has a rectangular shape having a recess at one end, that is, a substantially U-shape. Each highly-formable laminate film 37 is disposed such that an inner end portion that constitutes the recess is located slightly on the outer peripheral side relative to the inner ends of the frames 34A. The highly-formable laminate films 37 are disposed such that ends facing closest to each other overlap the projections 34B. As an example, each highly-formable laminate film 37 includes a PP layer of 30 μm, a PPa layer of 30 μm, an aluminum layer of 80 μm, a nylon (Ny) layer of 25 μm, an adhesive layer of approximately 1.5 μm, and a polyethylene terephthalate (PET) layer of 12 μm that are laminated in this order from the aluminum foil 32 side, and has a thickness of approximately 178.5 μm.

At the boundaries between the highly-formable laminate films 37 and the sealant film 34 (refer to FIG. 2B), four strip-shaped insulating films 38 are disposed across the boundaries. Each of the insulating films 38 is made of the same material as the sealant film 34 described above.

As shown in FIG. 2E, in an embossing process, the laminate film laminated in this manner is embossed along a dotted line indicated by arrow 39 to form a recess 30A on its center and a flange 30B on its outer peripheral edge. The flange 30B corresponds to the “peripheral edge” of the present disclosure and serves as a seal portion when the exterior bodies 31 are bonded together with the electrode module 20 enclosed inside.

A spike leakage test is performed on the exterior bodies 31 formed in this manner.

Next, a process of assembling the exterior member 30 will be described. In FIGS. 3C and 3D, a port portion 50, which will be described further below, is schematically shown. The electrode module 20 shown in FIG. 3A has already undergone a depressurization and sealing process and a self-discharge test.

As shown in FIG. 3A, the electrode module 20 has a substantially rectangular parallelepiped shape, and includes a pouring port frame 12 having a pouring port (not shown) into which the electrolytic solution is poured, and a board portion 14 for detecting the voltage of each of the bipolar electrodes 22 that constitutes the secondary battery 10. The board portion 14 includes a flexible printed circuits (FPC) board 14A that is an example of a voltage detection circuit board including a circuit that detects voltage, and the FPC board 14A is held at its both ends in one direction by FPC housings 14B. In FIGS. 3A, 3B, 3C, and 3D, the end current collector 26A is exposed at the center of an end face of the electrode stack 21 in the up-down direction. A known sealing process necessary for sealing with the PP layer of the flange 30B of the exterior body 31 on the recess 30A side is performed on the FPC board 14A. In the present embodiment, hereinbelow, the side on which the board portion 14 is provided is referred to as the reference short side, and the side opposite to the reference short side is referred to as the counter-reference short side.

Next, as shown in FIG. 3B, the cover member 16 having a hollow shape is disposed on each of the reference short side and the counter-reference short side of the electrode module 20.

Next, as shown in FIG. 3C, the exterior bodies 31 are assembled from both sides to the electrode module 20 with the cover members 16 disposed to enclose the electrode module 20. An enclosed space S is formed inside the assembled exterior bodies 31. In addition, when the exterior bodies 31 are assembled, the port portion 50, which will be described further below, is disposed between the flanges 30B of the exterior bodies 31, the flanges 30B facing each other.

Next, as shown in FIG. 3D, the flanges 30B of the exterior bodies 31 are overlaid and joined together. At this time, as shown in FIGS. 3A, 3B, 3C, and 3D, the flanges 30B are located on the FPC board 14A. Also, as described above, the port portion 50 is located between the flanges 30B of the exterior bodies 31. In the present embodiment, as an example, the port portion 50 is disposed at a position that does not overlap the FPC board 14A on the reference short side, and more specifically, the port portion 50 is disposed such that a part of the port portion 50 communicates with the inside of the enclosed space S defined by the recesses 30A facing each other.

In the present embodiment, faces of the flanges 30B of the exterior bodies 31, the faces facing each other, are PP layers, and thermal welding is used as an example of a method of joining the PP layers together.

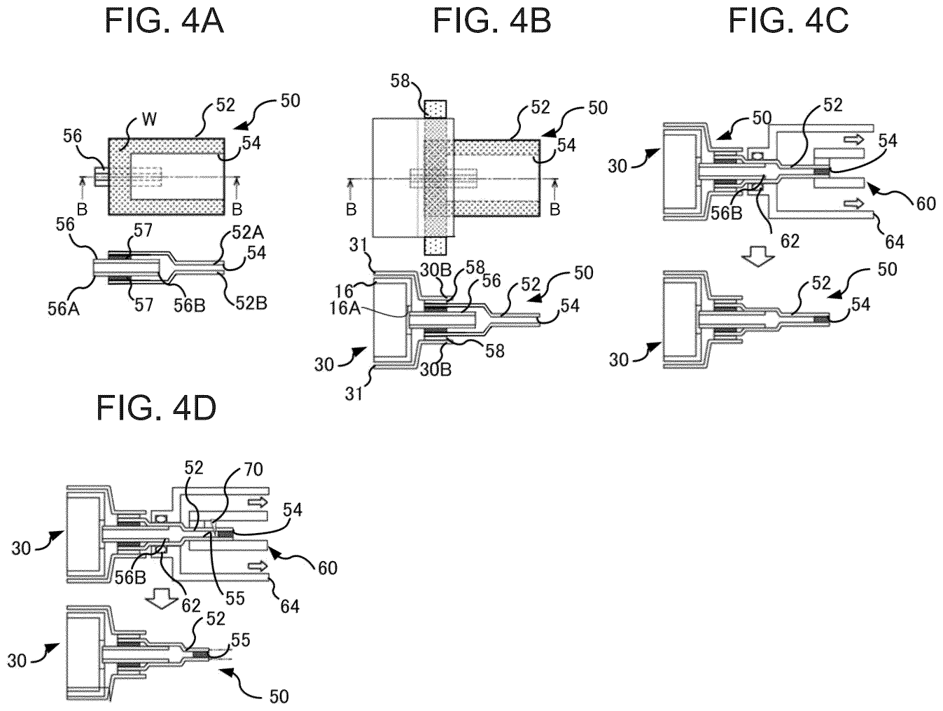

Next, the port portion 50 will be described. In each of FIGS. 4A and 4B, the lower drawing is a B-B sectional view of the upper drawing. As shown in FIG. 4A, the port portion 50 includes a seal portion 52 having a bag shape, and a metal pipe 56 having a cylindrical shape. As an example, the seal portion 52 includes rectangular laminate films 52A, 52B, and has a peripheral edge sealed with the laminate films 52A, 52B overlaid except one side. Specifically, as an example, the sealing of the peripheral edge is performed by thermally welding an area W indicated by shading in the upper drawing of FIG. 4A. The peripheral edge of the seal portion 52 has an opening 54 formed on the unsealed side.

In addition, each of the laminate films 52A, 52B that face each other and constitute the seal portion 52 includes a PP layer of 30 μm, an aluminum layer of 80 μm, and a PP layer of 30 μm that are laminated in this order from the side on which the laminate films 52A, 52B face each other, and has a thickness of approximately 140 μm. A film equivalent to that used for the exterior body 31 can be used as each of the laminate films 52A, 52B. The seal portion 52 may be formed by folding one laminate film and thermally welding its peripheral edge.

As shown in the lower drawing of FIG. 4A, as an example, a first end portion 56A of the metal pipe 56 on the left side of the paper is disposed outside the seal portion 52, and the first end portion 56A communicates with the inside of the enclosed space S. A second end portion 56B of the metal pipe 56 other than the first end portion 56A is disposed inside the seal portion 52. That is, the second end portion 56B of the metal pipe 56 is disposed between the overlaid laminate films 52A, 52B that constitute the seal portion 52.

The second end portion 56B of the metal pipe 56 is fixed at its part adjacent to the first end portion 56A with the peripheral edge of the seal portion 52 through a sealant film 57 having an outer peripheral face composed of a PPa layer. Specifically, the area W corresponds to the above-mentioned adjacent part, and when the peripheral edges of the laminate films of the seal portion 52 are thermally welded in the seal portion 52, the adjacent part is also thermally welded at the peripheral edge.

The port portion 50 formed in this manner is fixed to the exterior member 30 between the flanges 30B of the exterior bodies 31 by being thermally welded in a range indicated by shading 58 in FIG. 4B as an example. At this time, the first end portion 56A is inserted into the inside of the cover member 16 through an insertion hole 16A provided in the cover member 16 and communicates with the inside of the enclosed space S. In addition, the port portion 50 has the opening 54 on the side opposite to the side on which the port portion 50 is fixed to the exterior member 30.

Next, a depressurization process will be described. As shown in the upper drawing of FIG. 4C, the opening 54 of the seal portion 52 is sealed by, for example, an impulse sealer 60 after air is exhausted through the opening 54. As an example, the exhaust of air through the opening 54 is performed by a deaeration box 64 that is open on the side corresponding to the opening 54 in a state in which a seal member 62 seals the metal pipe 56 at a position corresponding to the second end portion 56B over the laminate films 52A, 52B that constitute the seal portion 52. The opening 54 of the seal portion 52 is closed by the impulse sealer 60 thermally sealing an end portion of the seal portion 52 at the opening 54 side after the exhaust of air through the opening 54 is performed. Then, as shown in the lower drawing of FIG. 4C, the impulse sealer 60, the seal member 62, and the deaeration box 64 are removed to complete depressurization and sealing of the enclosed space S. In this manner, the secondary battery 10 is formed by the depressurization and sealing using the port portion 50.

Next, re-depressurization and re-sealing will be described. The secondary battery 10 formed as described above may, as it is used, allow oxygen or nitrogen to enter the inside of the exterior member 30 in the market environment due to aged deterioration of the exterior member 30. If oxygen or nitrogen enters the inside of the exterior member 30, the internal pressure of the enclosed space S may increase. In this case, in the present embodiment, it is possible to perform re-depressurization and re-sealing in which the internal pressure of the enclosed space S is reduced and sealing is performed again.

As shown in FIG. 4D, the closed opening 54 is opened by being cut away with a blade 70, and a new second opening 55 is formed in the seal portion 52. The second opening 55 is sealed by the impulse sealer 60 after air is exhausted through the second opening 55 in the same manner as in the depressurization process shown in FIG. 4C described above. This makes it possible to perform re-depressurization and re-sealing. After the re-depressurization and re-sealing is performed, as shown in the lower drawing of FIG. 4D, the sealed second opening 55 is shorter in the remaining portion than the first opening 54 by the length of the cut-away portion.

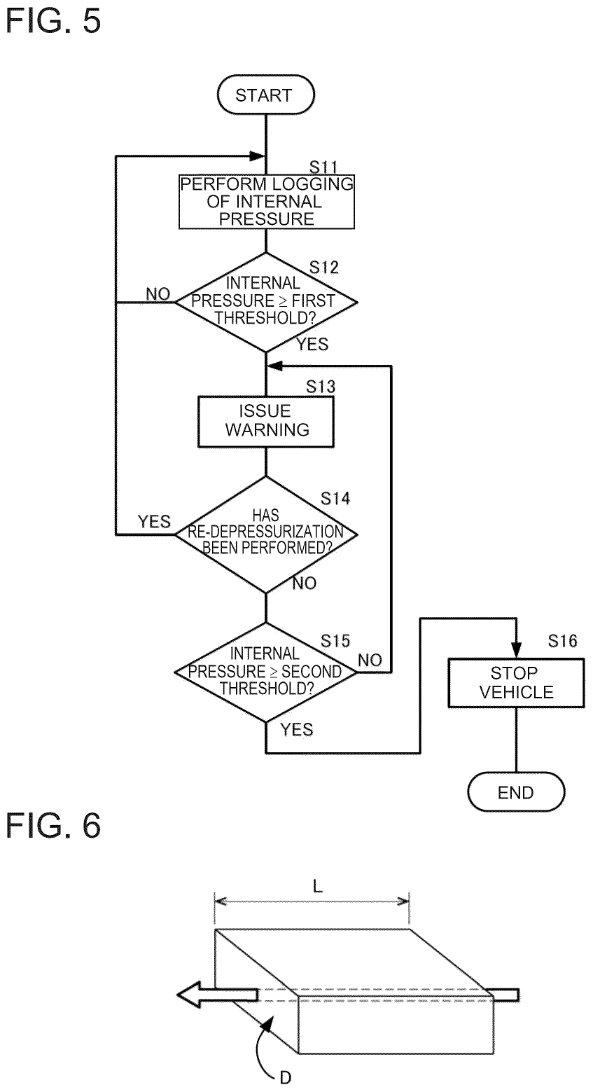

Next, a method of controlling the secondary battery 10 configured as described above will be described. In the present embodiment, as an example, the secondary battery 10 is controlled by an electronic control unit (ECU; not shown) that is provided in a vehicle (not shown) equipped with the secondary battery 10. As shown in FIG. 5, first, in step S11, the ECU performs logging of the internal pressure of the enclosed space S. As an example, measurement of the internal pressure of the enclosed space S is performed by obtaining an output from an internal pressure sensor P (refer to FIG. 1) that is disposed inside the enclosed space S in advance. Specifically, a signal is taken out from the welded portion of the laminate films in the FPC board 14A.

As an example, the internal pressure of the enclosed space S may be estimated by deriving the amount of air entering the exterior member 30. In this case, as shown in FIG. 6, the length of the laminate films that constitute the pair of exterior bodies 31 at the position where the port portion 50 is disposed is referred to as the transmission seal length L of air transmission (refer to FIG. 1). The cross-sectional area of a face of the pair of exterior bodies 31 perpendicular to the transmission seal length L is referred to as the cross-sectional area D of air transmission, and the air pressure inside the enclosed space is denoted by P_{IN}, and the air pressure outside the enclosed space (the outside air pressure) is denoted by P_{OUT}. In addition, the air transmittance of the resin (laminate film) is denoted by α, the temperature of the resin (laminate film) is denoted by T, and the amount of air passing through the resin (laminate film) per unit time is denoted by Q. In this case, the following formula (1) holds.

Q=(P_{OUT}−P_{IN})×D/L×α∝P_{OUT}×T (1)

The outside air pressure P_{OUT} is 0 kPa and assumed to be constant value. The transmission seal length L is assumed to be constant, although the length may slightly vary due to manufacturing variations and other factors in actuality. The air transmittance α of the resin depends on the temperature T of the resin.

The internal pressure may be estimated by measuring the outside air pressure P_{OUT} and the resin temperature T and deriving the amount of entering air Q based on these values and the above formula (1).

Next, in step S12, the ECU determines whether a value of the internal pressure obtained in step S11 is equal to or greater than a first threshold. The first threshold is a preset threshold that is a warning reference value for the internal pressure of the enclosed space S at which the re-depressurization and re-sealing needs to be performed.

When the value of the internal pressure is equal to or greater than the first threshold in step S12 (step S12; YES), the ECU issues a warning in step S13. As an example, the warning may be performed by producing a warning sound from a speaker provided in the vehicle or by displaying “please re-depressurize the secondary battery” on a display screen provided in the vehicle.

On the other hand, when the value of the internal pressure is less than the first threshold in step S12 (step S12; NO), the ECU shifts the process to step S11 and continues the process of step S11 and the subsequent steps.

Next, in step S14, the ECU determines whether re-depressurization has been performed. As an example of the determination on whether re-depressurization has been performed, when re-depressurization is performed, an operator or the like may input a signal indicating that the re-decompression has been performed to the ECU, and the ECU may determine whether the signal has been input to the ECU. That is, after a predetermined time elapses since the warning is issued in step S13, the process of step S14 is performed. When re-depressurization has been performed (step S14; YES), the ECU shifts the process to step S11 and continues the process of step S11 and the subsequent steps.

On the other hand, when no re-depressurization has been performed (step S14; NO), in step S15, the ECU determines whether a value of the current internal pressure is equal to or greater than a second threshold. The second threshold is a preset threshold that is a reference value for the internal pressure of the enclosed space S at which damage may be caused. When the value of the internal pressure is equal to or greater than the second threshold in step S15 (step S15; YES), in step S16, the ECU stops the vehicle and finishes all the processes.

On the other hand, when the value of the internal pressure is less than the second threshold in step S15 (step S15; NO), the ECU shifts the process to step S13, issues a warning again, and continues the process of step S14 and the subsequent steps.

Next, the actions and effects of the secondary battery 10 in the first embodiment will be described.

In the secondary battery 10 according to the present embodiment, the port portion 50 that communicates with the enclosed space S inside the exterior member 30 and is capable of opening and closing the enclosed space S is provided in at least a part of the peripheral edge sealed with the laminate films overlaid. Thus, air inside the enclosed space S can be discharged by the port portion 50 bringing the enclosed space S into an open state. This can reduce the pressure inside the enclosed space S. Thus, it is possible to generate a confining force inside the exterior member 30 formed of the laminate films.

In the secondary battery 10 according to the present embodiment, the seal portion 52 has a bag shape, the first end portion 56A of the metal pipe 56 communicates with the inside of the enclosed space S, and the second end portion 56B is disposed inside the seal portion 52. The outer peripheral face of the second end portion 56B is at least partially fixed with the laminate films on the peripheral edge of the seal portion 52 through the sealant film 57.

Thus, air inside the enclosed space S can be allowed to flow into the metal pipe 56 through the first end portion 56A, discharged into the seal portion 52 having a bag shape through the second end portion 56B of the metal pipe 56, and discharged to the outside through the unsealed part of the peripheral edge of the seal portion 52.

In the secondary battery 10 according to the present embodiment, the seal portion 52 has the opening 54 at the part of the peripheral edge. The opening 54 is closable. The second opening 55 is formable by cutting away the closed opening 54. This makes it possible to open and close the inside of the seal portion 52.

In the method of controlling the secondary battery 10 according to the present embodiment, when the internal pressure of the enclosed space S is equal to or higher than the predetermined first threshold, the warning for depressurizing the inside of the enclosed space S using the port portion 50 is issued. Thus, a user can recognize the necessity of depressurizing the inside of the enclosed space S. When the user recognizes the necessity of the depressurization, the pressure inside the enclosed space S can be reduced using the port portion 50. Thus, a confining force can be generated inside the exterior member 30 formed of the laminate films.

Hereinbelow, a secondary battery 10A according to a second embodiment of the present disclosure will be described with reference to the drawings. The secondary battery 10A of the present embodiment includes a port portion 80 having a configuration that differs from the configuration of the port portion 50 of the first embodiment described above. In the present embodiment, the configuration other than the port portion is the same as that of the secondary battery 10 of the first embodiment described above. Thus, only the port portion 80 will be described in detail.

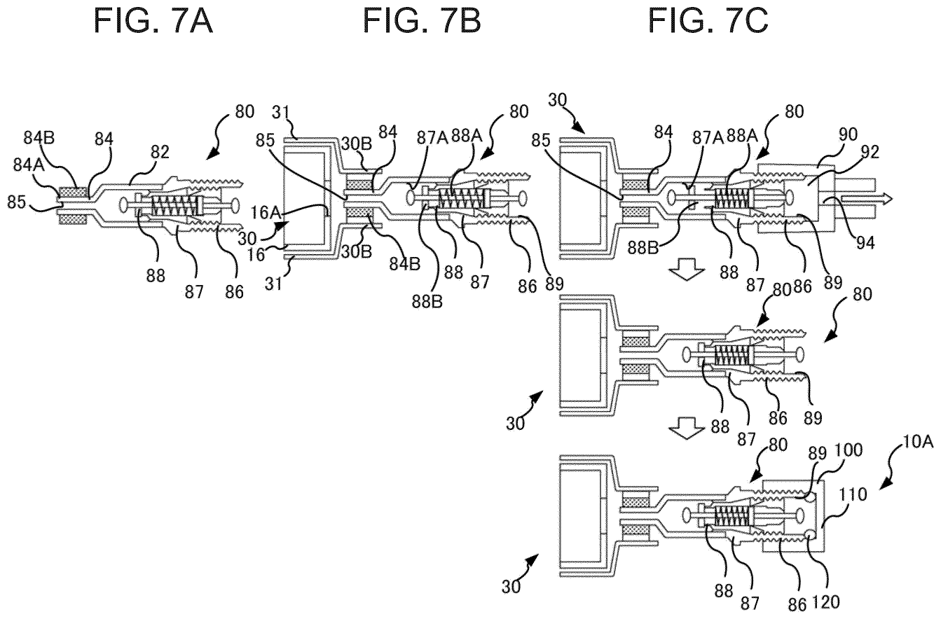

As shown in FIG. 7A, the port portion 80 includes a valve portion 82. The valve portion 82 has a first end portion 84 on the exterior member 30 side. The first end portion 84 is formed of a metal pipe and provided with a flat portion 84A. An end of the flat portion 84A has an inlet 85 through which air flows in. The inlet 85 of the first end portion 84 communicates with the inside of the enclosed space S. Specifically, as shown in FIG. 7B, the first end portion 84 is disposed with the inlet 85 facing the insertion hole 16A of the cover member 16. Front and back faces of the flat portion 84A (the upper and lower faces in FIG. 7A) are fixed to the exterior member 30 by being thermally welded between the laminate films of the flanges 30B of the exterior bodies 31 through a sealant film 84B.

The valve portion 82 includes a valve body 87 having a substantially cylindrical shape on a second end portion 86 on the outer side, and a valve core 88. The valve body 87 includes, inside thereof, an air passage 87A that communicates with the inlet 85 at the first end portion 84. The valve core 88 includes a spring member 88A and is movable in its axial direction through the air passage 87A of the valve body 87. The spring member 88A is biased outward by the internal pressure of the enclosed space S, and the biasing force causes a seal member 88B provided on the valve core 88 to close the air passage 87A. In the present embodiment, as an example, an end of the valve body 87 on the outer side has an outlet 89 through which air is discharged.

Next, a depressurization process will be described. As shown in the upper drawing of FIG. 7C, an exhaust valve 90 is attached to the outer side of the valve body 87. The exhaust valve 90 has a cylindrical shape having a space 92 inside thereof and has an exhaust hole 94 on the outer side. The exhaust hole 94 communicates with the space 92. The exhaust valve 90 is attached to outer side of the valve body 87 by screwing. This attachment makes the pressure inside the space 92 higher than the pressure inside the air passage 87A, which weakens the biasing force of the spring member 88A. When the biasing force of the spring member 88A is weakened, the valve core 88 moves toward the exterior member 30. Thus, the seal member 88B opens the air passage 87A.

When the air passage 87A is opened, as shown in the upper drawing of FIG. 7C, air inside the enclosed space S is discharged through the outlet 89 and discharged to the outside through the exhaust hole 94. After the pressure inside the enclosed space S reaches a desired internal pressure, when the exhaust valve 90 is removed as shown in the middle drawing of FIG. 7C, the spring member 88A is biased outward again by the internal pressure of the enclosed space S, and the biasing force causes the seal member 88B provided on the valve core 88 to close the air passage 87A.

As shown in the lower drawing of FIG. 7C, a cap 100 is attached to the outer side of the valve body 87 with the air passage 87A closed. As an example, the cap 100 is formed of a metal member, and includes a metal cap 110 and a metal seal 120. The metal cap 110 has a circular box shape having a bottom, and the open side thereof is attached to the valve body 87 by screwing. The metal seal 120 is interposed between the metal cap 110 and the valve body 87. In the present embodiment, as an example, as shown in the lower drawing of FIG. 7C, the port portion 80 is attached to the exterior member 30 with the cap 100 attached to the valve body 87, and the secondary battery 10A is completed with the port portion 80 attached in this manner.

Next, re-depressurization and re-sealing will be described. In the present embodiment, by removing the cap 100, and attaching the exhaust valve 90 to the outer side of the valve body 87 again as shown in the upper drawing of FIG. 7C, the inside of the enclosed space S can be depressurized again by the action described above. Then, after the depressurization, the exhaust valve 90 is removed from the valve body 87, and the cap 100 is attached to the valve body 87. In this manner, re-depressurization and re-sealing can be performed.

Next, the actions and effects of the secondary battery 10A in the second embodiment will be described.

In the secondary battery 10A according to the present embodiment, the port portion 80 has the first end portion 84 that has the inlet 85 and communicates with the inside of the enclosed space S, and the second end portion 86 that has the outlet 89 and is disposed outside the enclosed space S. In addition, the valve portion 82 capable of opening and closing the air passage 87A from the inlet 85 to the outlet 89 is provided. Thus, air inside the enclosed space S can be allowed to flow in through the inlet 85 and discharged through the outlet 89 by the valve portion 82 bringing the air passage 87A into an open state.

In the secondary battery 10A according to the present embodiment, the front and back faces of the flat portion 84A provided at the first end portion 84 having the inlet 85 are fixed with the laminate films through the sealant film 84B. Thus, compared to a case in which an outer peripheral face of a tubular portion is fixed with the laminate films, the sealability can be improved.

In the secondary battery 10A according to the present embodiment, since the cap 100 is attached to the valve body 87, air leakage through the outlet 89 can be reduced.

### Supplementary Description

Although, in the embodiments described above, the electrode module 20 includes the electrode stack 21 having the bipolar electrodes 22 stacked, the present disclosure is not limited to thereto. The electrode module 20 may include a typical electrode stack that does not have the bipolar electrodes 22, that is, an electrode stack having a plurality of cells stacked.

Although, in the second embodiment described above, the valve portion 82 has the configuration described above, the present disclosure is not limited to thereto. The valve portion 82 may have any configuration that can discharge air, and a known technique can be used.

Although, in the embodiments described above, the laminate films and the sealant films that constitute the exterior member 30 and the seal portion 52 have the configuration described above, the present disclosure is not limited to thereto. The material can be changed as appropriate.

The configuration of the present disclosure is not limited to the above embodiments, and the configuration can be changed as appropriate as long as the problems can be solved.

What is claimed is:

1. A secondary battery comprising:
an exterior member including laminate films, the exterior member having a peripheral edge sealed with the laminate films overlaid and having an enclosed space inside;
an electrode module housed in the enclosed space; and
a port portion configured to open and close the enclosed space, the port portion being provided in at least a part of the peripheral edge and communicating with the enclosed space, wherein
the port portion includes a valve portion,
the valve portion has
a first end portion having an inlet through which air flows in and communicating with inside of the enclosed space, and
a second end portion having an outlet through which air is discharged and being disposed outside the enclosed space, and
the valve portion is configured to open and close an air passage from the inlet to the outlet.

2. The secondary battery according to claim 1, wherein the valve portion has a flat portion provided at the first end portion, and front and back faces of the flat portion are fixed with the laminate films on the peripheral edge through a sealant film.

3. A secondary battery comprising:
an exterior member including laminate films, the exterior member having a peripheral edge sealed with the laminate films overlaid and having an enclosed space inside;
an electrode module housed in the enclosed space; and
a port portion configured to open and close the enclosed space, the port portion being provided in at least a part of the peripheral edge and communicating with the enclosed space, wherein
the port portion includes
a seal portion including second laminate films, the seal portion having a peripheral edge sealed with the second laminate films overlaid except a part of the peripheral edge and having a bag shape, and
a metal pipe having
a first end portion disposed outside the seal portion and communicating with the enclosed space, and
a second end portion other than the first end portion, the second end portion being disposed inside the seal portion and having an outer peripheral face at least partially fixed with the second laminate films on the peripheral edge of the seal portion through a second sealant film.

4. The secondary battery according to claim 3, wherein:
the seal portion has an opening in the part of the peripheral edge;
the opening is closable; and
a second opening is formable by cutting away the opening closed.

5. A method of controlling the secondary battery according to claim 1, the method comprising:
measuring an internal pressure of the enclosed space; and
issuing a warning for depressurizing inside of the enclosed space using the port portion when the internal pressure measured is equal to or higher than a predetermined threshold.

6. A method of controlling the secondary battery according to claim 3, the method comprising:
measuring an internal pressure of the enclosed space; and
issuing a warning for depressurizing inside of the enclosed space using the port portion when the internal pressure measured is equal to or higher than a predetermined threshold.
